(19) United States
(12) Patent Application Publication
(10) Pub. No.: US 2021/0138573 A1
(43) Pub. Date: May 13, 2021

(54) AIR-COOLED TORCH HEAD ASSEMBLY

(71) Applicant: Ji Yun Hwang, Ulsan (KR)

(72) Inventor: Ji Yun Hwang, Ulsan (KR)

(21) Appl. No.: 17/010,916

(22) Filed: Sep. 3, 2020

(30) Foreign Application Priority Data
Nov. 13, 2019 (KR) 10-2019-0144654

(51) Int. Cl. B23K 9/32

(52) U.S. Cl. CPC B23K 9/32; B23K 9/167

(57) ABSTRACT

According to the present invention, a first buffer member and a second buffer member have first perforated holes and second perforated holes, which are offset at predetermined intervals, respectively, so that generation of heat due to reduction of current density per unit area is reduced, and a detachment preventing part is provided at a lower portion of a torch head rubber cover to prevent slipping during use. In order to effectively block radiant heat emitted from a molten pool during the use, a heat shielding curtain part is provided, and a plurality of grooves are formed in an inner diameter portion of the heat shielding curtain part, so that the rubber cover is prevented from being damaged by swelling due to rapid entry of a gas.

### CROSS-REFERENCE TO RELATED APPLICATIONS

This application claims the benefit of Republic of Korea Patent Application 10-2019-0144654 (filed 13 Nov. 2019), the entire disclosure of which is hereby incorporated by reference herein.

### BACKGROUND OF THE INVENTION

### 1. Field of the Invention

The present invention relates to an air-cooled torch head, and more particularly, to an air-cooled torch head assembly capable of extending a service life without easily deforming or damaging a rubber cover on a torch head.

### 2. Description of the Prior Art

A flexible air-cooled torch is used to perform welding by supplying an argon gas from a tungsten inert gas (TIG) welding head to generate an arc between the argon gas and tungsten. Such an air-cooled torch is classified into a fixed air-cooled torch and a flexible air-cooled torch, and especially in the case of the flexible air-cooled torch, an external finishing material is formed of rubber due to use and structural characteristics. In the case of an air-cooled torch head formed of a rubber material, a rubber cover is easily deformed or easily damaged due to high heat during the welding, so that a service life is not prolonged. In order to solve such a problem, as shown in FIG. 1 attached hereto, Korean utility model registration No. 20-0262822 entitled “Air-cooled Torch” discloses a structure in which grooves 2 are formed in a torch head 1 at a predetermined interval, an outer diameter portion of the groove 2 is fixedly covered with a mesh net 3, and a rubber cover is fixed to an outer side of the mesh net 3 by using an adhesive. Accordingly, even when the torch head 1 is heated to higher temperatures, the rubber cover is not easily deformed and separated due to the mesh net 3, so that a service life may be extended.

### SUMMARY OF THE INVENTION

In the case of the related art, since current density per unit area is reduced due to the groove 2 of the torch head 1 so as to generate heat, the adhesive bonded with the rubber cover may be melted, so that the rubber cover may be easily deformed and separated. In addition, the rubber cover of the torch head may be easily deformed due to radiant heat of a molten pool during work, and upon abnormally rapid entry of a gas (argon), the rubber cover may swell so as to be detached and deformed.

In order to solve the above problem, according to the present invention, an air-cooled torch head assembly including a torch head connection member formed at a center thereof with a gas supply tube to supply a gas to a torch, and formed at an outer diameter portion thereof with a first inclined part, an insertion part, and a first step, which are sequentially arranged, and a torch head body having a through-hole connected to the gas supply tube, formed at an inner diameter portion thereof with a male thread part, and formed at an outer diameter portion thereof with a second step, a second insertion part, and a second inclined part, which are sequentially arranged, the air-cooled torch head assembly includes:

a first buffer member formed at an inner diameter portion thereof with a third step on which the second step is mounted, including a first protrusion provided at a lower portion of the third step, including a second-first inclined part provided at a lower portion of the first protrusion and inclined toward the inner diameter portion of the first buffer member, and formed at a center thereof with a first through-hole;

a first cover formed at a center thereof with a first perforated hole, and insert-molded at an outer diameter portion of the first protrusion;

a second buffer member having a second through-hole and a second-first through-hole, which are sequentially arranged in a transverse direction from a center of the first through-hole, including a gas blocking part having a triangular shape and protruding upward from an outer diameter portion of the second-first through-hole, and including a second protrusion formed in an extension direction of the gas blocking part; and

a second cover formed at a center thereof with a second perforated hole, and insert-molded at an outer diameter portion of the second protrusion.

In addition, the air-cooled torch head assembly may further include:

a torch head rubber cover including a detachment preventing part having a lower through-hole and on which the first buffer member is mounted, having an upper through-hole formed at an upper portion of the detachment preventing part, and having a head insertion part formed between the lower through-hole and the upper through-hole and in which the first buffer member is mounted; and

a handle rubber cover having a handle through-hole formed in the transverse direction from the head insertion part, including heat shielding curtain parts provided on a bottom surface of the handle through-hole at equidistant intervals, having reinforcement grooves formed in an inner diameter portion of the heat shielding curtain part at a predetermined interval, and including a corrugated part provided on an outer side of an end of the reinforcement groove.

According to the present invention, the first buffer member and the second buffer member have first perforated holes and second perforated holes, which are offset at predetermined intervals, respectively, so that the generation of heat due to the reduction of the current density per unit area can be reduced, and the detachment preventing part is provided at a lower portion of the torch head rubber cover to prevent slipping during use. In order to effectively block the radiant heat emitted from the molten pool during the use, the heat shielding curtain part is provided, and a plurality of grooves are formed in the inner diameter portion of the heat shielding curtain part, so that the rubber cover can be prevented from being damaged by the swelling due to the rapid entry of the gas.

### BRIEF DESCRIPTION OF THE DRAWINGS

FIG. 1 is an actual photograph of a conventional torch head.

FIG. 2 is a view showing a first buffer member and a second buffer member according to the present invention.

FIG. 3 is a view showing a torch head body and a torch head connection member mounted in the configuration of FIG. 2.

FIG. 4 shows a view and partially enlarged views illustrating a state in which the torch head body is coupled and welded to the first buffer member according to the present invention.

FIG. 5 shows a view and partially enlarged views illustrating a state in which the torch head connection member is coupled and welded to the second buffer member according to the present invention.

FIG. 6 is a view showing a coupled state of a first cover and a second cover according to the present invention.

FIG. 7 is a partially cutaway view according to a first embodiment of the present invention.

FIG. 8 is a view showing a torch head rubber cover and a handle rubber cover according to the present invention.

FIG. 9 is a perspective view showing a state in which the torch head rubber cover and the handle rubber cover are coupled to the first buffer member and the second buffer member, respectively, according to the present invention.

FIG. 10 is a partially cutaway view according to a second embodiment of the present invention.

### DETAILED DESCRIPTION OF THE EXEMPLARY EMBODIMENTS

Hereinafter, exemplary embodiments of the present invention will be described in detail with reference to the accompanying drawings. First, when reference numerals are given to elements of each of the drawings, it should be noted that the same reference numerals are used to designate the same or similar elements even when they are shown in different drawings. In addition, in the following description of the present invention, detailed descriptions of well-known configurations or functions incorporated herein may be omitted when they make the subject matter of the present invention rather unclear.

In the following description of the present invention, the terms are defined by taking into consideration the functions in the present invention, and may vary according to the intention of a person skilled in the art or the practice. Therefore, the definition of the term shall be made based on the contents throughout the specification.

An air-cooled torch head assembly including a torch head connection member 10 famed at a center thereof with a gas supply tube 11 to supply a gas to a torch, and formed at an outer diameter portion thereof with a first inclined part 12, an insertion part 13, and a first step 14, which are sequentially arranged, and a torch head body 20 having a through-hole 21 connected to the gas supply tube 11, formed at an inner diameter portion thereof with a male thread part 22, and formed at an outer diameter portion thereof with a second step 23, a second insertion part 24, and a second inclined part 25, which are sequentially arranged, the air-cooled torch head assembly includes:

a first buffer member 30 formed at an inner diameter portion thereof with a third step 31 on which the second step 23 is mounted, including a first protrusion 32 provided at a lower portion of the third step 31, including a second-first inclined part 33 provided at a lower portion of the first protrusion 32 and inclined toward the inner diameter portion of the first buffer member 30, and formed at a center thereof with a first through-hole 34;

a first cover 30-1 formed at a center thereof with a first perforated hole 35, and insert-molded at an outer diameter portion of the first protrusion 32;

a second buffer member 40 having a second through-hole 41 and a second-first through-hole 42, which are sequentially arranged in a transverse direction from a center of the first through-hole 34, including a gas blocking part 43 having a triangular shape and protruding upward from an outer diameter portion of the second-first through-hole 42, and including a second protrusion 45 formed in an extension direction of the gas blocking part 43; and

a second cover 40-1 formed at a center thereof with a second perforated hole 46, and insert-molded at an outer diameter portion of the second protrusion 45.

In addition, air-cooled torch head assembly may further include:

a torch head rubber cover 50 including a detachment preventing part 52 having a lower through-hole 51 and on which the first buffer member 30 is mounted, having an upper through-hole 53 famed at an upper portion of the detachment preventing part 52, and having a head insertion part 54 formed between the lower through-hole 51 and the upper through-hole 53 and in which the first buffer member 30 is mounted; and

a handle rubber cover 60 having a handle through-hole formed in the transverse direction from the head insertion part 54, including heat shielding curtain parts 62 provided on a bottom surface of the handle through-hole at equidistant intervals, having reinforcement grooves formed in an inner diameter portion of the heat shielding curtain part 62 at a predetermined interval, and including a corrugated part 65 provided on an outer side of an end of the reinforcement groove 64.

The present invention having the structure as described above includes the first buffer member 30 and the second buffer member 40 according to a first embodiment.

An object of the first embodiment is to solve problems of an air-cooled torch head formed of a rubber material, in which a rubber cover is easily defamed or easily damaged due to high heat during welding so that a service life is not prolonged, and a groove is formed and fixed with a mesh net, but current density per unit area is rather reduced so as to apply a load, which causes an adhesive that fixes the rubber cover to be melted, so that the rubber cover is easily deformed and separated.

In order to achieve the above object, according to the present invention, the first cover 30-1 formed at the center thereof with the first perforated hole 35 may be formed at the outer diameter portion of the first protrusion 32 of the first buffer member 30 by an insert-molding process, the first buffer member 30 may be formed of a rubber material, and the first cover 30-1 may be formed of a copper material.

The first protrusion 32 may be provided in an inner diameter portion of the first perforated hole 35, and may be mounted in the second insertion part 24 disposed between the second step 23 and the second inclined part 25 when the first protrusion 32 is coupled to the torch head body 20.

In addition, in order to completely couple the first buffer member 30 to the torch head body 20, as shown in “A” that is a partially enlarged view of FIG. 4 attached hereto, the first cover 30-1 insert-molded with the first buffer member 30 may be fixed to the torch head body 20 by a first welding part 100. In other words, a lower inner diameter surface of the first cover 30-1 may make surface contact with an upper vertical surface of the second inclined part 25, and the lower inner diameter surface of the first cover 30-1 may be welded to the upper vertical surface of the second inclined part 25 by the first welding part 100, so that the first buffer member 30 may be fixed to a lower portion of the torch head body 20.

As shown in “B” of FIG. 4, the second step 23 of the torch head body 20 may make surface contact with the third step 31 of the first buffer member 30. Meanwhile, the first cover 30-1 insert-molded with the first buffer member 30 may be fixed to the second step 23 of the torch head body 20 by a second welding part 200. In addition, an upper inner diameter surface of the first cover 30-1 may make surface contact with a surface of the second step 23 of the torch head body 20, and the upper inner diameter surface of the first cover 30-1 may be welded to the surface of the second step 23 of the torch head body 20 by the second welding part 200, so that the first buffer member 30 may be fixed to an upper portion of the torch head body 20. Further, the torch head body 20 and the first cover 30-1 may be formed of the same material, which is the copper material.

The first through-hole 34 may be formed at the center of the first buffer member 30, and the second buffer member 40 may have the second through-hole 41 and the second-first through-hole 42, which are sequentially arranged in the transverse direction from the center of the first through-hole 34.

The second protrusion 45 may be provided at an outer diameter portion based on the second-first through-hole 42, and the second protrusion 45 may be mounted in the insertion part 13 when the second protrusion 45 is coupled to the torch head connection member 10. A space part 44 may be formed at an inner diameter portion of the second protrusion 45, and a gas blocking part 43 having a triangular shape may be formed at an inner diameter portion of the space part 44.

In order to fix the second buffer member 40 to the torch head connection member 10, as shown in FIG. 5 attached hereto, the torch head connection member 10 may be fixed to an end of the gas blocking part 43 by a third welding part 300. In other words, the end of the gas blocking part 43 may make surface contact with the torch head connection member 10, and the end of the gas blocking part 43 may be welded to the torch head connection member 10 by the third welding part 300, so that the second buffer member 40 may be fixed to a left side portion of the torch head connection member 10. In addition, an inner diameter portion of an end of the second buffer member 40 may make surface contact with the first step 14 of the torch head connection member 10, and the inner diameter portion of the end of the second buffer member 40 may be welded to the first step 14 of the torch head connection member 10 by a fourth welding part 400, so that the second buffer member 40 may be fixed to a right side portion of the torch head connection member 10. The second buffer member 40 and the torch head connection member 10 may be formed of the same material, which is the copper material. In addition, a gas (argon) may move in a predetermined direction due to the gas blocking part 43 upon use.

The present invention includes the torch head rubber cover 50 and the handle rubber cover 60 according to a second embodiment. An object of the second embodiment of the present invention is to solve a problem that an adjacent rubber cover is easily deformed and separated due to radiant heat that is emitted directly or indirectly from a molten pool during use.

In order to achieve the above object, according to the present invention, the torch head rubber cover 50 and the handle rubber cover 60 may be provided. The torch head rubber cover 50 may be formed at an upper portion thereof with the upper through-hole 53, may be formed at a lower portion thereof with the lower through-hole 51, may have the head insertion part 54 formed between the lower through-hole 51 and the upper through-hole 53 to surround an outer diameter portion of the first buffer member 30 as shown in FIG. 10 attached thereto, and may have the detachment preventing part 52 to prevent slipping of the torch head rubber cover 50.

The handle rubber cover 60 may have the handle through-hole 61 formed in the transverse direction from the head insertion part 54. The handle rubber cover 60 may be provided on a bottom surface thereof with a plurality of heat shielding curtain parts 62 that are synchronously configured to ensure smooth ventilation so as to reduce the radiant heat emitted directly or indirectly from the molten pool during the use, so that the handle rubber cover 60 may be prevented from being deformed or separated.

In addition, a plurality of reinforcement grooves 64 having a rectangular shape may be formed in an inner diameter portion of the handle rubber cover 60 to enhance durability, in order to prevent a negligent accident that the handle rubber cover expands so as to be detached or damaged upon abnormally rapid entry of the gas (argon).

What is claimed is:

1. An air-cooled torch head assembly including a torch head connection member formed at a center thereof with a gas supply tube to supply a gas to a torch, and formed at an outer diameter portion thereof with a first inclined part, an insertion part, and a first step, which are sequentially arranged, and a torch head body having a through-hole connected to the gas supply tube, formed at an inner diameter portion thereof with a male thread part, and formed at an outer diameter portion thereof with a second step, a second insertion part, and a second inclined part, which are sequentially arranged, the air-cooled torch head assembly comprising:
a first buffer member formed at an inner diameter portion thereof with a third step on which the second step is mounted, including a first protrusion provided at a lower portion of the third step, including a second-first inclined part provided at a lower portion of the first protrusion and inclined toward the inner diameter portion of the first buffer member, and formed at a center thereof with a first through-hole;
a first cover formed at a center thereof with a first perforated hole, and insert-molded at an outer diameter portion of the first protrusion;
a second buffer member having a second through-hole and a second-first through-hole, which are sequentially arranged in a transverse direction from a center of the first through-hole, including a gas blocking part having a triangular shape and protruding upward from an outer diameter portion of the second-first through-hole, and including a second protrusion formed in an extension direction of the gas blocking part; and
a second cover formed at a center thereof with a second perforated hole, and insert-molded at an outer diameter portion of the second protrusion.

2. The air-cooled torch head assembly of claim 1, further comprising:
a torch head rubber cover including a detachment preventing part having a lower through-hole and on which the first buffer member is mounted, having an upper through-hole formed at an upper portion of the detachment preventing part, and having a head insertion part formed between the lower through-hole and the upper through-hole and in which the first buffer member is mounted; and
a handle rubber cover having a handle through-hole formed in the transverse direction from the head insertion part, including heat shielding curtain parts provided on a bottom surface of the handle through-hole at equidistant intervals, having reinforcement grooves formed in an inner diameter portion of the heat shielding curtain part at a predetermined interval, and including a corrugated part provided on an outer side of an end of the reinforcement groove.
